(19) United States
(12) Patent Application Publication
(10) Pub. No.: US 2024/0369953 A1
(43) Pub. Date: Nov. 7, 2024

(54) DEVELOPING DEVICE AND IMAGE FORMING APPARATUS INCLUDING THE SAME

(71) Applicant: KYOCERA Document Solutions Inc., Osaka (JP)

(72) Inventor: Koichi IMANAKA, Osaka (JP)

(73) Assignee: KYOCERA Document Solutions Inc., Osaka (JP)

(21) Appl. No.: 18/561,100

(22) PCT Filed: Mar. 16, 2022
(86) PCT No.: PCT/JP2022/011903

§ 371 Date: Nov. 15, 2023

(30) Foreign Application Priority Data
May 19, 2021 (JP) 2021-084529

(51) Int. Cl. G03G 15/08; G03G 21/16

(52) U.S. Cl. CPC G03G 15/0889; G03G 15/0881; G03G 21/1647

(57) ABSTRACT

A developing device includes a developing container, a stirring conveyance member, a pair of shaft supports, and a pair of bearings. The stirring conveyance member includes a rotary shaft and a stirring vane. The shaft supports are coupled to both ends of the rotary shaft in an axial direction. The bearings rotatably support the shaft supports. The rotary shaft has a first through hole penetrating through the rotary shaft over an entire region thereof in the axial direction. The shaft supports are inserted from both the ends of the rotary shaft in the axial direction into the first through hole, and each of the shaft supports has a second through hole penetrating through the each of the shaft supports over an entire region thereof in the axial direction so as to communicate with the first through hole.

### TECHNICAL FIELD

The present invention relates to a developing device and an image forming apparatus including the same.

### BACKGROUND ART

An image forming apparatus using an electrophotographic method, such as a copy machine, a printer, a facsimile, or a multi-functional peripheral equipped with functions thereof, includes a developing device for forming a toner image (a visible image) by developing an electrostatic latent image formed on an outer circumferential surface of an image carrying member, i.e., by rendering the electrostatic latent image visible.

Such a developing device is described in Patent Literature 1 to include a developing container containing a developer including a toner, a stirring conveyance member that stirs and conveys the developer in the developing container, and a developing roller having a part exposed through an opening formed in the developing container (Patent Literature 1). The stirring conveyance member includes a rotary shaft rotatably supported to the developing container and a stirring vane formed on an outer circumferential surface of the rotary shaft. The rotary shaft is supported to bearings provided in the developing device so as to be rotatable. The stirring vane rotates about the rotary shaft, and thus the developer in a developer containing portion is supplied to the developing roller while circulating in the developing container.

### CITATION LIST

### Patent Literature

### Patent Literature 1: Japanese Unexamined Patent Application Publication No. 2013-127566

### SUMMARY OF INVENTION

### Technical Problem

Meanwhile, in the developing device configured as above, friction may occur between the stirring conveyance member and the bearings, causing an increase in temperature of the stirring conveyance member. When increased in temperature, the stirring conveyance member might be deformed or degraded. Furthermore, there is also a possibility that heat from the stirring conveyance member is diffused to an entire area of the developing device, resulting in a development failure due to degradation of a developer, a stirring failure due to solidification (blocking) of the developer, or an increase in stirring torque.

With the foregoing as a background, it is an object of the present invention to provide a developing device capable of suppressing a temperature increase.

### Solution to Problem

In order to achieve the above-described object, a first configuration of the present invention relates to a developing device including a developing container, a stirring conveyance member, a pair of shaft supports, and a pair of bearings. The developing container contains a developer including a toner. The stirring conveyance member includes a rotary shaft and a stirring vane formed on an outer circumferential surface of the rotary shaft and stirs and conveys the developer in the developing container. The shaft supports are coupled to both ends of the rotary shaft in an axial direction. The bearings rotatably support the shaft supports. The rotary shaft has a first through hole penetrating through the rotary shaft over an entire region thereof in the axial direction. The shaft supports are inserted from both the ends of the rotary shaft in the axial direction into the first through hole, and each of the shaft supports has a second through hole penetrating through the each of the shaft supports over an entire region thereof in the axial direction so as to communicate with the first through hole.

### Advantageous Effects of Invention

According to the first configuration of the present invention, the first through hole penetrates through the rotary shaft over the entire region thereof in the axial direction. This facilitates dissipation of heat from the stirring conveyance member to air inside the first through hole and thus can suppress an increase in temperature of the stirring conveyance member. Furthermore, the first through hole communicates with the second through hole, and the second through hole penetrates through each of the shaft supports over the entire region thereof in the axial direction. This facilitates replacement of air in the first through hole with air outside the stirring conveyance member through the second through hole and thus further facilitates dissipation of heat from the stirring conveyance member. Furthermore, with the second through hole formed in each of the shaft supports, it is possible to efficiently dissipate frictional heat generated between the shaft supports and the bearings and thus to suppress an increase in temperature of the shaft supports themselves.

### BRIEF DESCRIPTION OF DRAWINGS

FIG. 1 is a sectional view showing an internal structure of an image forming apparatus 100 in which developing devices 3a to 3d are mounted according to an embodiment of the present invention.

FIG. 2 is a perspective view showing the developing device 3a in a state where a cover member 61 and a developing roller 31 have been demounted therefrom.

FIG. 3 is a sectional side view of the developing device 3a in a state where the cover member 61 and the developing roller 31 have been mounted thereto.

FIG. 4 is a sectional plan view showing a cross section of a stirring portion in the developing device 3a as cut along an A-A sectional line shown in FIG. 3.

FIG. 5 is a partially enlarged view obtained by enlarging a part of the developing device 3a enclosed by a circle B drawn with a chain double-dashed line in FIG. 4.

### DESCRIPTION OF EMBODIMENT

With reference to the appended drawings, the following describes an embodiment of developing devices 3a to 3d and an image forming apparatus 100 including the developing devices 3a to 3d according to the present invention. A direction along a rotary shaft 23 provided in each of the developing devices 3a to 3d according to the present invention is referred to as an “axial direction.” Furthermore, a direction along a diameter direction of the rotary shaft 23 is referred to as a “radial direction.”

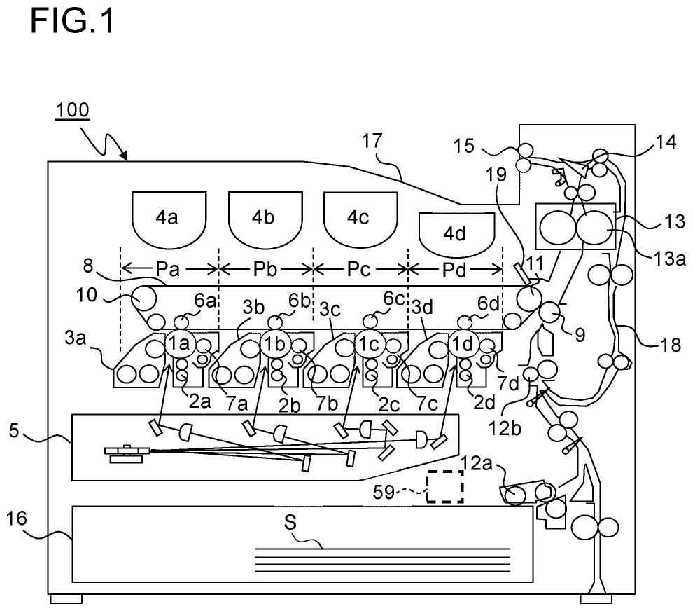

FIG. 1 is a sectional view showing an internal structure of the image forming apparatus 100 in which the developing devices 3a to 3d are mounted according to the embodiment of the present invention. In a main body of the image forming apparatus 100 (herein, a color printer), four image forming portions Pa, Pb, Pc, and Pd are arrayed in this order from an upstream side (a left side in FIG. 1) in a conveyance direction. The image forming portions Pa to Pd are provided so as to correspond to images of four different colors (cyan, magenta, yellow, and black) and sequentially form images of cyan, magenta, yellow, and black, respectively, by individually performing steps of charging, exposure, development, and transfer.

In the image forming portions Pa to Pd, photosensitive drums (image carrying members) 1a, 1b, 1c, and 1d that carry visible images (toner images) of the respective colors are arrayed, respectively, and an intermediate transfer belt 8 that rotates in a counterclockwise direction in FIG. 1 is provided adjacently to the image forming portions Pa to Pd. Toner images formed on the photosensitive drums 1a to 1d are sequentially and primarily transferred in a superimposed manner on the intermediate transfer belt 8 moving in contact with the photosensitive drums 1a to 1d. After that, by a secondary transfer roller 9, the toner images that have been primarily transferred on the intermediate transfer belt 8 are secondarily transferred on a transfer sheet S as an example of a recording medium. Moreover, after the toner images that have been secondarily transferred on the transfer sheet S are fixed in a fixing portion 13, the transfer sheet S is discharged from the main body of the image forming apparatus 100. While the photosensitive drums 1a to 1d are rotated in a clockwise direction in FIG. 1 by a main motor (not shown), an image forming process with respect to each of the photosensitive drums 1a to 1d is executed.

The transfer sheet S on which toner images are to be secondarily transferred is housed in a sheet cassette 16 disposed in a lower part of the main body of the image forming apparatus 100 and is conveyed to a nip between the secondary transfer roller 9 and a driving roller 11 of the intermediate transfer belt 8 via a paper feed roller 12a and a registration roller pair 12b. As the intermediate transfer belt 8, mainly used is a (seamless) belt having no seam and formed of a dielectric resin sheet. Furthermore, a blade-shaped belt cleaner 19 for removing a toner or the like remaining on a surface of the intermediate transfer belt 8 is disposed on a downstream side of the secondary transfer roller 9.

Next, a description is given of the image forming portions Pa to Pd. Charging devices 2a, 2b, 2c, and 2d that charge the photosensitive drums 1a to 1d, respectively, an exposure device 5 that performs exposure based on image information with respect to the photosensitive drums 1a to 1d, developing devices 3a, 3b, 3c, and 3d that form toner images on the photosensitive drums 1a to 1d, respectively, and cleaning devices 7a, 7b, 7c, and 7d that remove a residual developer (toner) or the like remaining on the photosensitive drums 1a to 1d, respectively, are provided around and below the photosensitive drums 1a to 1d rotatably arrayed.

Upon image data being inputted from a host apparatus such as a personal computer, first, surfaces of the photosensitive drums 1a to 1d are uniformly charged by the charging devices 2a to 2d, respectively. Then, by the exposure device 5, light is applied thereto so as to correspond to the image data, and thus electrostatic latent images corresponding to the image data are formed on the photosensitive drums 1a to 1d. The developing devices 3a to 3d are filled with prescribed amounts of two-component developers including toners of the respective colors of cyan, magenta, yellow, and black, respectively. In a case where a percentage of the toners in the two-component developers filled in the developing devices 3a to 3d falls below a preset value due to after-mentioned toner image formation, the developing devices 3a to 3d are replenished with fresh supplies of toners from toner containers 4a to 4d, respectively. The toners in the developers are supplied onto the photosensitive drums 1a to 1d by the developing devices 3a to 3d, respectively, and electrostatically adhere thereto to form toner images corresponding to the electrostatic latent images formed by exposure from the exposure device 5.

Further, each of primary transfer rollers 6a to 6d applies an electric field at a prescribed transfer voltage between itself and a corresponding one of the photosensitive drums 1a to 1d so that the toner images of cyan, magenta, yellow, and black on the photosensitive drums 1a to 1d are primarily transferred on the intermediate transfer belt 8. These images of the four colors are formed in a prescribed positional relationship predetermined for formation of a prescribed full-color image. After that, a residual toner or the like remaining on the surfaces of the photosensitive drums 1a to 1d after the primary transfer is removed by the cleaning devices 7a to 7d, respectively, in preparation for subsequent formation of new electrostatic latent images.

The intermediate transfer belt 8 is stretched over a driven roller 10 on an upstream side and the driving roller 11 on a downstream side. As the driving roller 11 is driven to rotate by a belt drive motor (not shown), the intermediate transfer belt 8 starts to rotate in the counterclockwise direction, and then the transfer sheet S is conveyed at prescribed timing from the registration roller pair 12b to the nip (a secondary transfer nip) between the driving roller 11 and the secondary transfer roller 9, where the full-color image on the intermediate transfer belt 8 is secondarily transferred on the transfer sheet S. The transfer sheet S on which the toner images have been secondarily transferred is conveyed to the fixing portion 13.

The transfer sheet S thus conveyed to the fixing portion 13 is heated and pressed by a fixing roller pair 13a so that the toner images are fixed on a surface of the transfer sheet S, and thus a prescribed full-color image is formed thereon. A conveyance direction of the transfer sheet S on which the full-color image has been formed is controlled by a branch portion 14 branching off in a plurality of directions, and thus the transfer sheet S is directly (or after being conveyed to a double-sided conveyance path 18 and thus subjected to image formation on both sides thereof) discharged to a discharge tray 17 by a discharge roller pair 15.

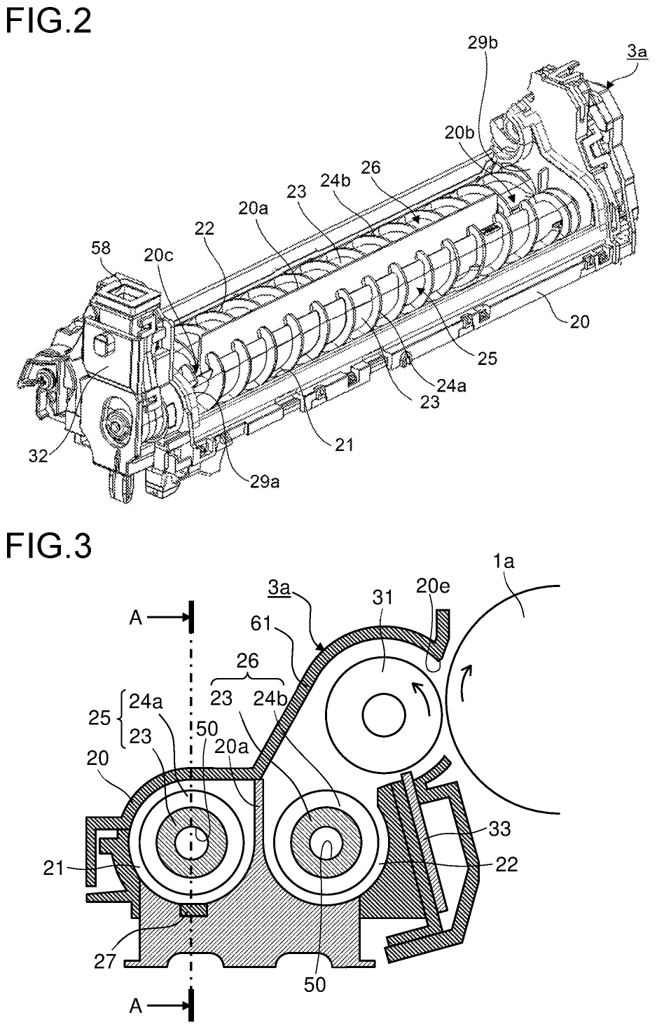

FIG. 2 is a perspective view showing the developing device 3a in a state where a cover member 61 and a developing roller 31 have been demounted therefrom. FIG. 3 is a sectional side view of the developing device 3a in a state where the cover member 61 and the developing roller 31 have been mounted thereto. While the following description uses, as an example, the developing device 3a disposed in the image forming portion Pa in FIG. 1, the developing devices 3b to 3d disposed in the image forming portions Pb to Pd, respectively, are basically similar in configuration to the developing device 3a, and thus descriptions thereof are omitted.

As shown in FIG. 2 and FIG. 3, the developing device 3a includes a developing container 20 for containing a two-component developer (hereinafter, also referred to simply as a developer) including a magnetic carrier and a toner. The developing container 20 includes the cover member 61 provided at an upper part of the developing container 20 and a partition wall 20a provided inside the developing container 20. The cover member 61 closes the upper part of the developing container 20 and separates an internal space of the developing container 20 from an external space thereof. The partition wall 20a partitions the internal space of the developing container 20 into a stirring conveyance chamber 21 and a supply conveyance chamber 22.

A first stirring conveyance member 25 is provided in the stirring conveyance chamber 21, and a second stirring conveyance member 26 is provided in the supply conveyance chamber 22. The stirring conveyance members (the first stirring conveyance member 25 and the second stirring conveyance member 26) make a mixture of a toner supplied from the toner container 4a (see FIG. 1) and the magnetic carrier and stir the mixture so that the toner is charged. Each of the first stirring conveyance member 25 and the second stirring conveyance member 26 is rotatably supported, via shaft supports 52 provided at both ends thereof in the axial direction, to bearings 28 secured to the developing container 20 (details thereof will be described later).

The first stirring conveyance member 25 and the second stirring conveyance member 26 rotate to convey, while stirring, the developer in the axial direction (a direction perpendicular to a drawing plane of FIG. 3) so that the developer circulates between the stirring conveyance chamber 21 and the supply conveyance chamber 22 via communication portions 20b and 20c formed at both ends of the partition wall 20a. That is, the stirring conveyance chamber 21, the supply conveyance chamber 22, and the communication portions 20b and 20c constitute a circulation path of the developer in the developing container 20.

As shown in FIG. 3, the developing roller (a developer carrying member) 31 is disposed on a diagonally upper right side of the second stirring conveyance member 26 in the developing container 20. Further, a part of an outer circumferential surface of the developing roller 31 is exposed through an opening 20e of the developing container 20 and is opposed to the photosensitive drum 1a. The developing roller 31 rotates in a counterclockwise direction in FIG. 3. The first stirring conveyance member 25, the second stirring conveyance member 26, and the developing roller 31 rotate at a prescribed rotation speed by using a drive force from the main motor (not shown).

The developing roller 31 is composed of a cylindrical developing sleeve (not shown) that rotates in the counterclockwise direction in FIG. 3 and a magnet (not shown) that has a plurality of magnetic poles and is secured in the developing sleeve. While the developing sleeve used herein has a knurled surface, it is also possible to use a developing sleeve having a surface with a multitude of concaves (dimples) formed therein, a developing sleeve having a blasted surface, a developing sleeve having a surface not only knurled and including concaves formed therein but also blasted, or a developing sleeve having a plated surface.

As shown in FIG. 3, in the developing container 20, a regulation blade 33 is attached along a longitudinal direction of the developing roller 31 (the direction perpendicular to the drawing plane of FIG. 3). A slight clearance (gap) is formed between a tip end of the regulation blade 33 and a surface of the developing roller 31. The regulation blade 33 uses the slight clearance to regulate a layer thickness of the toner supplied onto the outer circumferential surface of the developing roller 31 to a prescribed thickness.

A developing voltage power supply (not shown) is connected to the developing device 3a via a voltage control circuit (not shown). The developing voltage power supply applies, to the developing roller 31, a developing voltage obtained by superimposing a direct-current voltage on an alternating-current voltage. Under the developing voltage and a magnetic force of the magnet in the developing roller 31, the developer adheres to (is carried on) the surface of the developing roller 31 so as to form a magnetic brush thereon.

As shown in FIG. 3, a toner concentration sensor 27 is disposed at a bottom surface of the stirring conveyance chamber 21 so as to be opposed to the first stirring conveyance member 25 in a height direction (an up-down direction in FIG. 3). The toner concentration sensor 27 is connected to a control portion 59 (see FIG. 1) provided at a prescribed location in the image forming apparatus 100. The toner concentration sensor 27 detects a magnetic permeability of the developer in the developing container 20 and transmits a result of the detection to the control portion 59. Based on the detection result, the control portion 59 determines a toner concentration in the developer (a mixing ratio T/C of the toner to the carrier in the developer) and thus determines whether or not to perform toner replenishment.

In performing the toner replenishment, the control portion 59 transmits a control signal to a toner replenishment motor (not shown). Based on the control signal, the toner replenishment motor supplies each of the toners in the toner containers 4a to 4d into the developing container 20 via a toner replenishment portion 32 (see FIG. 2). In this case, the control portion 59 controls the toner concentration sensor 27 to detect a toner concentration in the developer in the developing container 20 and performs the toner replenishment while controlling the toner replenishment motor so that the toner concentration thus detected attains a prescribed reference value.

As shown in FIG. 2, the toner replenishment portion 32 is provided on an upstream side (a near left side in FIG. 2) of the stirring conveyance chamber 21. The toner replenishment portion 32 includes a replenishment port 58 open to an upper part of the developing device 3a and a toner replenishment path (not shown) extending downward from the replenishment port 58 and communicating with the stirring conveyance chamber 21. The replenishment port 58 is connected to the toner container 4a (see FIG. 1). The toner contained in the toner container 4a is supplied to the stirring conveyance chamber 21 through the replenishment port 58 and the toner replenishment path.

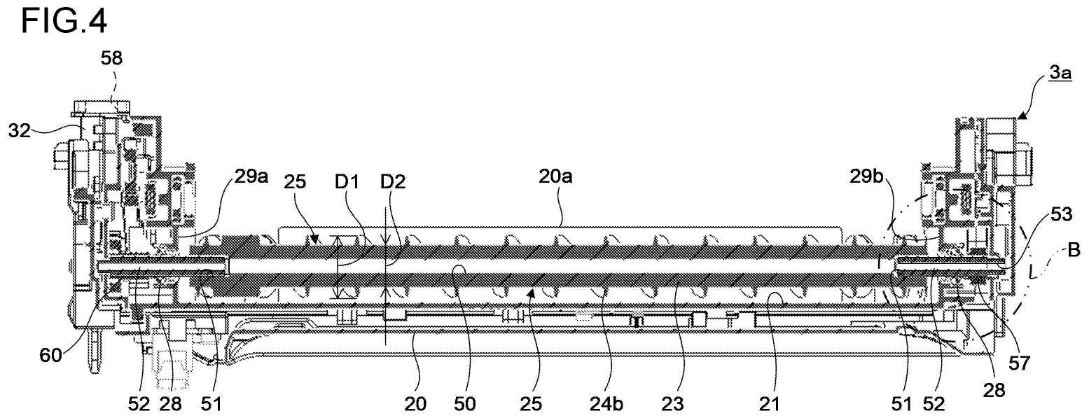

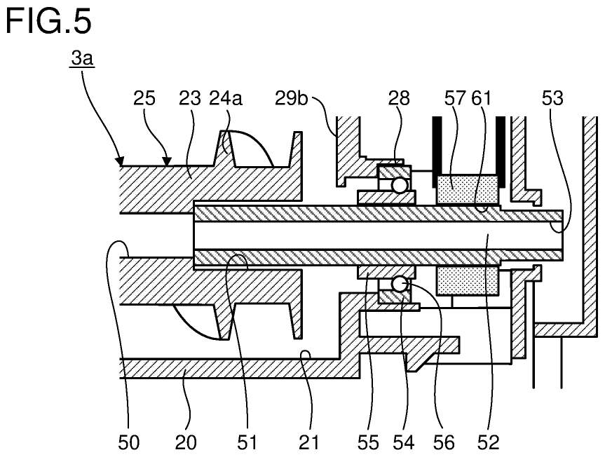

Next, a detailed description is given of a configuration of a stirring portion of the developing device 3a. FIG. 4 is a sectional plan view showing a cross section of the stirring portion in the developing device 3a as cut along an A-A sectional line shown in FIG. 3. FIG. 5 is a partially enlarged view obtained by enlarging a part of the developing device 3a enclosed by a circle B drawn with a chain double-dashed line in FIG. 4.

As shown in FIG. 2 to FIG. 4, as described above, the stirring conveyance chamber 21, the supply conveyance chamber 22, the partition wall 20a, an upstream communication portion 20b, and a downstream communication portion 20c are formed in the developing container 20. Furthermore, in addition thereto, the toner replenishment portion 32 and side walls 29a and 29b (opposed walls) are also formed in the developing container 20.

The partition wall 20a extends in a longitudinal direction of the developing container 20, forming a partition between the stirring conveyance chamber 21 and the supply conveyance chamber 22 so that they are juxtaposed to each other. One end of the partition wall 20a (on a right side in FIG. 4) in a longitudinal direction, together with the side wall 29b of the developing container 20, constitutes the upstream communication portion 20b. The other end of the partition wall 20a (on a left side in FIG. 4) in the longitudinal direction, together with the side wall 29a of the developing container 20, constitutes the downstream communication portion 20c.

The first stirring conveyance member 25 includes the rotary shaft 23 and a helical vane 24a. The second stirring conveyance member 26 includes another rotary shaft 23 and a helical vane 24b (a stirring vane). The first stirring conveyance member 25 and the second stirring conveyance member 26 have a configuration basically common to each other except that the helical vane 24a and the helical vane 24b are opposite in helical direction to each other. The description, therefore, is directed mainly to the first stirring conveyance member 25, and as for the second stirring conveyance member 26, only differences thereof from the first stirring conveyance member 25 are described.

As shown in FIG. 2 to FIG. 4, the rotary shafts 23 are each a cylindrical shaft body extending along the longitudinal direction of the developing container 20 (a conveyance direction of the developer). The rotary shafts 23 extend up to vicinities of both ends of the developing container 20 in the axial direction. Both ends of each of the rotary shafts 23 are opposed in the axial direction to the side walls 29a and 29b.

Each of the helical vanes 24a and 24b is formed on an outer circumferential surface of a corresponding one of the rotary shafts 23. Each of the helical vanes 24a and 24b is formed integrally with a corresponding one of the rotary shafts 23 and helically at a given pitch in the axial direction. The helical vane 24a and the helical vane 24b are formed in helical directions opposite to each other. Each of the helical vanes 24a and 24b extends towards both ends of the developing container 20 in a longitudinal direction so as to lie further at respective positions of the upstream communication portion 20b and the downstream communication portion 20c in the longitudinal direction. The helical vane 24b has a diameter D1 not less than 1.3 times and not more than 1.7 times (preferably, not less than 1.4 times and not more than 1.6 times) an outer diameter D2 of a corresponding one of the rotary shafts 23.

As shown in FIG. 3 to FIG. 5, at a center of each of the rotary shafts 23 in the radial direction, a first through hole 50 is formed to penetrate through the each of the rotary shafts 23 from one end to the other end thereof in the axial direction. Support concaves 51 are formed at both ends of the first through hole 50 in the axial direction. The support concaves 51 have an inner diameter larger than an inner diameter of the first through hole 50. That is, the first through hole 50 increases in diameter from a center thereof in the axial direction toward the support concaves 51.

As shown in FIG. 4 and FIG. 5, the shaft supports 52 are each a cylindrical shaft body elongated in the axial direction. The shaft supports 52 are made of a metal material (such as brass). The shaft supports 52 have an outer diameter not smaller than the inner diameter of the support concaves 51. The shaft supports 52 are inserted into the support concaves 51 so as to be secured to each of the rotary shafts 23. To be more specific, the shaft supports 52 are inserted (press-fitted) into the support concaves 51 with a tightening margin and thus are secured to each of the rotary shafts 23. Thus, the shaft supports 52 and the first stirring conveyance member 25 integrally rotate about each of the rotary shafts 23.

At a center of each of the shaft supports 52 in the radial direction, a second through hole 53 is formed to penetrate through the each of the shaft supports 52 over an entire region thereof in the axial direction. The second through hole 53 has an inner diameter substantially equal to or slightly smaller than that of the first through hole 50. In a state where the shaft supports 52 are secured to each of the rotary shafts 23, the second through hole 53 communicates with the first through hole 50.

The shaft supports 52 extend in the axial direction from the support concaves 51 and penetrate through the side walls 29a and 29b to protrude to outside the stirring conveyance chamber 21 or the supply conveyance chamber 22.

As shown in FIG. 4 and FIG. 5, the bearings 28 are disposed outside each of the first stirring conveyance member 25 and the second stirring conveyance member 26 (a depiction thereof is omitted) in the axial direction. The bearings 28 are secured to the side walls 29a and 29b. The bearings 28 are each a ball bearing composed of an outer ring 54, an inner ring 55, and rolling elements 56.

The outer ring 54 is secured to each of the side walls 29a and 29b. The inner ring 55 is secured to an outer circumferential surface of each of the shaft supports 52. The inner ring 55 has an outer diameter smaller than an inner diameter of the outer ring 54. The inner ring 55 is disposed at such a position as to overlap the outer ring 54 in the axial direction and is opposed to the outer ring 54 in the radial direction. The rolling elements 56 are spherical bodies. The rolling elements 56 are disposed between the outer ring 54 and the inner ring 55. The rolling elements 56 are disposed on respective opposed surfaces (raceway surfaces) of the outer ring 54 and the inner ring 55. The shaft supports 52 rotate to cause the outer ring 54 and the inner ring 55 to slide relative to the rolling elements 56 and to cause relative rotation between the outer ring 54 and the inner ring 55.

As shown in FIG. 4 and FIG. 5, a seal member 57 is provided on an outer side of each of the bearings 28 in the axial direction. The seal member 57 is an annular body formed of an elastic member made of an elastomer, rubber, or the like. The seal member 57 is externally fitted over each of the shaft supports 52. An inner surface of the seal member 57 in the radial direction is slidably in contact with the outer circumferential surface of each of the shaft supports 52. The seal member 57 is disposed between a wall of the developing container 20 and each of the shaft supports 52. The seal member 57 closes a clearance between the wall of the developing container 20 and each of the shaft supports 52, thus suppressing a phenomenon in which the developer in the stirring conveyance chamber 21 and the supply conveyance chamber 22 flows out to an exterior.

A drive gear 60 is coupled to one of the shaft supports 52 provided at each of the rotary shafts 23, which is positioned at one end (here, near the side wall 29a) of the each of the rotary shafts 23. The drive gear 60 is coupled to the main motor (not shown) and transmits a rotation drive force of the main motor to the one of the shaft supports 52. When the rotation drive force is transmitted to the one of the shaft supports 52, the first stirring conveyance member 25 (the second stirring conveyance member 26) rotates integrally with the shaft supports 52.

When the first stirring conveyance member 25 and the second stirring conveyance member 26 rotate, by the helical vanes 24a and 24b, the developer in the developing container 20 is stirred while circulating from the stirring conveyance chamber 21 to the upstream communication portion 20b, then to the supply conveyance chamber 22, and further to the downstream communication portion 20c (see FIG. 2). This is when the developer in the supply conveyance chamber 22 is supplied to the developing roller 31.

Meanwhile, typically, a required frequency of performing developer replenishment to a developing device may vary depending on a type of an image forming apparatus in which the developing device is mounted. In such a case, a developer fill amount (an amount of a developer to be filled in a developing container) also varies. For example, a developing device with a high required frequency of the replenishment is low in the developer fill amount, whereas a developing device with a low required frequency of the replenishment is high in the developer fill amount. In a case, however, where a developer ratio (a ratio between a volumetric capacity of a developing container and a volume of a developer in the developing container) is decreased when the developer fill amount is low, the developer may fail to be appropriately supplied to a developing roller. To avoid this, the developing device that is low in the developer fill amount may be configured to include a developing container reduced in size or a stirring conveyance member whose rotary shaft has a relatively increased diameter so that a volumetric capacity of a developing container is reduced, thus suppressing a decrease in the developer ratio.

Furthermore, typically, in a developing device, friction may occur between a drive gear that transmits a rotation drive force to a stirring conveyance member or bearings and the stirring conveyance member, causing an increase in temperature of the stirring conveyance member. When increased in temperature, the stirring conveyance member might be deformed or degraded. Particularly in the above-described developing device that includes the developing container reduced in volumetric capacity and is low in the developer fill amount, heat from the stirring conveyance member is unlikely to be dissipated via a developer and thus is likely to cause an increase in temperature of the stirring conveyance member. When increased in temperature, the stirring conveyance member might be deformed or degraded. Furthermore, there is also a possibility that heat from the stirring conveyance member is diffused to an entire area of the developing device, causing an increase in temperature of the developing device, which might adversely affect development using a developing roller, thus resulting in degradation of the developing device and an image forming apparatus.

In contrast, as described above, in the developing device 3a according to the present invention, the first through hole 50 is formed in each of the rotary shafts 23 and penetrates through the each of the rotary shafts 23 over an entire region thereof in the axial direction. This facilitates dissipation of heat from the first stirring conveyance member 25 and the second stirring conveyance member 26 to air inside the first through hole 50 and thus can suppress an increase in temperature of the first stirring conveyance member 25 and the second stirring conveyance member 26. Furthermore, the first through hole 50 communicates with the second through hole 53, and the second through hole 53 penetrates through each of the shaft supports 52 over an entire region thereof in the axial direction. This facilitates replacement of air in the first through hole 50 from inside to outside, and vice versa, of the first stirring conveyance member 25 and the second stirring conveyance member 26 through the second through hole 53 and thus further facilitates dissipation of heat from the first stirring conveyance member 25 and the second stirring conveyance member 26.

Furthermore, with the second through hole 53 formed in each of the shaft supports 52, it is possible to efficiently dissipate frictional heat generated between the shaft supports 52 and the bearings 28 and thus to suppress an increase in temperature of the shaft supports 52 themselves. Accordingly, it is possible to provide the developing device 3a capable of suppressing a temperature increase.

Furthermore, as described above, the seal member 57 is positioned on an outer side relative to each of the bearings 28 in the axis direction. The seal member 57, therefore, only comes in contact with a slight amount of developer that has passed through a clearance between each of the side walls 29a and 29b and a corresponding one of the bearings 28 or a clearance between each of the outer ring 54 and the inner ring 55 and the rolling elements 46. Consequently, when the shaft supports 52 rotate to cause the seal member 57 to slide relative to each of the shaft supports 52, frictional heat generated between the seal member 57 and the each of the shaft supports 52 is unlikely to be conducted to the developer. Accordingly, it is possible to suppress an increase in temperature of the developer.

Furthermore, as described above, the shaft supports 52 are made of a metal material. The shaft supports 52, therefore, has a relatively high thermal conductivity, and thus it is possible to efficiently dissipate heat from the shaft supports 52.

Furthermore, as described above, the helical vane 24b has a diameter not less than 1.3 times and not more than 1.7 times a diameter of the corresponding one of the rotary shafts 23. Specifically, the rotary shafts 23 are formed to have a diameter larger than a diameter of a rotary shaft in general use. The first through hole 50 formed in each of the rotary shafts 23, therefore, has a relatively increased inner diameter so that a volumetric capacity of a space inside the first through hole 50 can be increased. Accordingly, efficiency in heat dissipation from the first stirring conveyance member 25 and the second stirring conveyance member 26 is improved, and thus it is possible to suppress an increase in temperature of the first stirring conveyance member 25 and the second stirring conveyance member 26. Moreover, when the helical vane 24b has a diameter not less than 1.4 times and not more than 1.6 times the diameter of the corresponding one of the rotary shafts 23, it is possible to suppress a decrease in amount of the developer conveyed by the helical vane 24b while suppressing an increase in temperature of the first stirring conveyance member 25 and the second stirring conveyance member 26.

Other than the above, the present invention is not limited to the foregoing embodiment and can be variously modified without departing from the spirit of the present invention. For example, the present invention is applicable not only to a tandem color printer shown in FIG. 1 but also to various types of image forming apparatuses using a two-component development method, such as a digital or analog monochrome copy machine, a monochrome printer, a color copy machine, and a facsimile.

Furthermore, while the helical vane 24a of the first stirring conveyance member 25 and the helical vane 24b of the second stirring conveyance member 26 are formed in helical directions opposite to each other, it is also possible to employ a configuration in which the helical vanes 24a and 24b are formed in helical directions identical to each other. In this case, the first stirring conveyance member 25 and the second stirring conveyance member 26 are disposed to be reversely oriented to each other in the axial direction. With this configuration, the first stirring conveyance member 25 and the second stirring conveyance member 26 can be formed of an identical member, and this commonality of components makes it possible to suppress an increase in manufacturing cost.

Furthermore, while a ball bearing is used as each of the bearings 28, there is no limitation thereto, and instead, it is also possible to use, for example, a slide bearing including an inner ring and an outer ring that slide in direct contact with each other. Furthermore, the inner ring 55 can be configured to be integrally formed with each of the shaft supports 52. Similarly, the outer ring 54 can be configured to be integrally formed with the side walls 29a and 29b.

Furthermore, as described above, while the shaft supports 52 are configured to be press-fitted into the support concaves 51 so as to be secured thereto, the shaft supports 52 may be secured to the support concaves 51 by bonding or through engagement between an engagement protrusion formed on the outer circumferential surface of each of the shaft supports 52 and an engagement groove of a corresponding one of the support concaves 51. In this case, the shaft supports 52 can be formed to have an outer diameter smaller than an inner diameter of the support concaves 51.

Furthermore, it is also possible to employ a configuration in which the first through hole 50 and the second through hole 53 are formed only for one of the first stirring conveyance member 25 and the second stirring conveyance member 26.

### INDUSTRIAL APPLICABILITY

The present invention is usable in a developing device including a stirring conveyance member that conveys a developer while stirring it. Through the use of the developing device, it is possible to provide an image forming apparatus capable of suppressing an image formation failure and degradation of the developing device and the image forming apparatus.

1. A developing device, comprising:
a developing container that contains a developer including a toner;
a stirring conveyance member that includes:
a rotary shaft; and
a stirring vane that is formed on an outer circumferential surface of the rotary shaft,
the stirring conveyance member being configured to stir and convey the developer in the developing container;
a pair of shaft supports that is coupled to both ends of the rotary shaft in an axial direction; and
a pair of bearings that rotatably supports the shaft supports,
wherein
the rotary shaft has a first through hole penetrating through the rotary shaft over an entire region thereof in the axial direction, and
the shaft supports are inserted from both the ends of the rotary shaft in the axial direction into the first through hole, each of the shaft supports has a second through hole penetrating through the each of the shaft supports over an entire region thereof in the axial direction so as to communicate with the first through hole, and the second through hole has an inner diameter smaller than an inner diameter of the first through hole.

2. The developing device according to claim 1, further comprising:
a seal member that is provided between the developing container and each of the shaft supports and closes a clearance between the developing container and the each of the shaft supports,
wherein at a position on an outer side relative to each of the bearings in the axial direction, the seal member is in contact with an outer circumferential surface of a corresponding one of the shaft supports.

3. The developing device according to claim 1, wherein
the developing container includes a pair of opposed walls opposed to both the ends of the rotary shaft in the axial direction,
the shaft supports penetrate through the opposed walls in the axial direction, and
each of the bearings includes:
an outer ring that is provided at each of the opposed walls and is opposed to a corresponding one of the shaft supports in a radial direction of the rotary shaft; and
an inner ring that is rotatably supported to the outer ring and rotates together with the rotary shaft.

4. The developing device according to claim 1, wherein
the rotary shaft includes support concaves that are recessed inwardly in the axial direction from both the ends of the rotary shaft and are larger in diameter than the first through hole, and
the shaft supports are inserted into the support concaves so as to be secured to the rotary shaft.

5. The developing device according to claim 1, wherein
the shaft supports are made of a metal material.

6. The developing device according to claim 1, wherein
the stirring vane has a diameter not less than 1.3 times and not more than 1.7 times a diameter of the rotary shaft.

7. An image forming apparatus, comprising:
the developing device according to claim 1; and
an image carrying member that is opposed to a developer carrying member and carries, on a surface thereof, the toner supplied from the developer carrying member.

8. A developing device, comprising:
a developing container that contains a developer including a toner;
a stirring conveyance member that includes:
a rotary shaft; and
a stirring vane that is formed on an outer circumferential surface of the rotary shaft,
the stirring conveyance member being configured to stir and convey the developer in the developing container;
a pair of shaft supports that is coupled to both ends of the rotary shaft in an axial direction; and
a pair of bearings that rotatably supports the shaft supports,
wherein
the developing device further comprises:
a seal member that is provided between the developing container and each of the shaft supports and closes a clearance between the developing container and the each of the shaft supports,
the rotary shaft has a first through hole penetrating through the rotary shaft over an entire region thereof in the axial direction,
the shaft supports are inserted from both the ends of the rotary shaft in the axial direction into the first through hole, and each of the shaft supports has a second through hole penetrating through the each of the shaft supports over an entire region thereof in the axial direction so as to communicate with the first through hole, and
at a position on an outer side relative to each of the bearings in the axial direction, the seal member is disposed to be spaced apart from the each of the bearings in the axial direction and is in contact with an outer circumferential surface of a corresponding one of the shaft supports.
